(19) United States
(12) Patent Application Publication
(10) Pub. No.: US 2023/0301340 A1
(43) Pub. Date: Sep. 28, 2023

(54) Drizzle Drip Pan Device

(71) Applicants: Anna Coleman, Jacksonville, FL (US); Anthony Coleman, Jacksonville, FL (US)

(72) Inventors: Anna Coleman, Jacksonville, FL (US); Anthony Coleman, Jacksonville, FL (US)

(21) Appl. No.: 17/734,145

(22) Filed: May 2, 2022

Related U.S. Application Data
(60) Provisional application No. 63/322,836, filed on Mar. 23, 2022.

(51) Int. Cl. A23P 20/15; A21D 13/47; A21D 13/24; A21C 15/00

(52) U.S. Cl. CPC A23P 20/15; A21D 13/47; A21D 13/24; A21C 15/002

(57) ABSTRACT

The present invention relates to a novel rotating cake pan device designed to allow a user to place a cake or other dessert on the rotating platform, and then rotating the dessert during decorating. The device comprises a bottom base component positioned on a rotating turntable component. A detachable drainage reservoir drip-pan and a detachable cooling rack are all placed on top of the bottom base component. The bottom base component comprises four rubber plugs and a non-skid bottom which secures the bottom base component to the rotating turntable component during use. Thus, during decoration, any glaze or icing will drip off the cake and into the drip-pan, where it can be drizzled back onto the item or poured back into a storage container.

### CROSS-REFERENCE TO RELATED APPLICATION

The present application claims priority to, and the benefit of, U.S. Provisional Application No. 63/322,836, which was filed on Mar. 23, 2022 and is incorporated herein by reference in its entirety.

### FIELD OF THE INVENTION

The present invention relates generally to the field of cake pans. More specifically, the present invention relates to an improved cake pan device for decorating food items with icing. The device comprises a rotating turntable with a detachable platform and drainage reservoir catch-pan. Accordingly, the present disclosure makes specific reference thereto. Nonetheless, it is to be appreciated that aspects of the present invention are also equally applicable to other like applications, devices and methods of manufacture.

### BACKGROUND

By way of background, decorating cakes, pastries, strawberries, and other dessert items with a drizzle or glaze-style decoration can be messy and difficult as the icing is typically poured over the food item while in a baking pan or while on a tray or plate. This creates messy drips and drizzles, which require extensive cleanup after the desserts are decorated. Alternately, this requires the use of wax paper and/or aluminum foil to catch the glaze and drizzles, which can be expensive to purchase. Thus, a device that would prevent such messy drips and drizzles would be advantageous.

Furthermore, users decorating cakes and other desserts with a drizzle or glaze-style decoration are required to manually rotate the cake plate or tray to try and decorate the dessert from different angles, which can be difficult. Further, any excess icing that drips onto the countertop or tray base is left unusable and is wasted. Thus, a rotating device that catches any excess icing in a drip pan to prevent icing from being wasted would be advantageous.

Thus, it is necessary for users to have a rotatable tray for icing a variety of desserts. Further, the device should prevent the icing from being wasted, by catching the excess icing in a drip tray, which would allow the icing to be poured back into a storage container for reuse. Generally, the device should allow a user to easily rotate the cake plate during decorating.

Therefore, there exists a long-felt need in the art for a rotating cake pan device that provides users with a turntable and tray system for decorating food items with glaze and icing. There is also a long-felt need in the art for a rotating cake pan device that prevents chocolate, glaze, and icing, etc., from being wasted, instead allowing it to be reused for future food items. Further, there is a long-felt need in the art for a rotating cake pan device that enables users to rotate the turntable while decorating their items to ensure the dessert is decorated from all sides and angles. Moreover, there is a long-felt need in the art for a device that features multiple trays and a drip pan that can be used to support food items for decorating. Further, there is a long-felt need in the art for a rotating cake pan device that allows excess glaze and icing to flow into the drip pan for pouring the icing back into a storage container. Finally, there is a long-felt need in the art for a rotating cake pan device that eliminates messy drips and drizzles from requiring extensive cleanup after desserts are decorated.

The subject matter disclosed and claimed herein, in one embodiment thereof, comprises a rotating cake pan device. The device is designed to allow a user to place a cake or other dessert on the rotating platform, and then rotating the dessert during decorating. The device comprises a bottom base component positioned on a rotating turntable component. A detachable drainage reservoir catch-pan or drip-pan and a detachable cooling rack are all placed on top of the bottom base component. The bottom base component comprises four rubber plugs and a non-skid bottom which secures the bottom base component to the rotating turntable component during use. Thus, during decoration, any glaze or icing will drip-off the cake and into the drip-pan, where it can be drizzled back onto the item or poured back into a storage container.

In this manner, the rotating cake pan device of the present invention accomplishes all of the foregoing objectives and provides users with a device that prevents chocolate, glaze, icing, etc., from being wasted, instead allowing it to be reused for future food items. The device allows a user to rotate the turntable while decorating their items to ensure it is decorated from all sides and angles. The device eliminates messy drips and drizzles from requiring extensive cleanup.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rotating cake pan device. The device is designed to allow a user to place a cake or other dessert on the rotating platform, and then rotating the dessert during decorating. The device comprises a bottom base component positioned on a rotating turntable component. A detachable drainage reservoir catch-pan, or drip-pan, and a detachable cooling rack are all placed on top of the bottom base component. The bottom base component comprises four rubber plugs and a non-skid bottom which secures the bottom base component to the rotating turntable component during use. Thus, during decoration, any glaze or icing will drip-off the cake and into the drip-pan, where it can be drizzled back onto the item or poured back into a storage container.

In one embodiment, the rotating turntable component comprises a rotational coupling or turntable assembly. The turntable assembly includes an upper member, or rotating member and a lower member, or base member. A plurality of bearing members, such as ball bearings, are interposed between the rotating member and the base member to facilitate relative rotation between the members. In addition, outer peripheral edges of the members are configured in an interlocking arrangement, which prevents separation of the members in an axial direction.

In another embodiment, a bottom base component is then secured to the turntable component. The bottom base component can be any suitable size and/or shape as is known in the art, depending on the needs and/or wants of a user. For example, the bottom base component can be rectangular or circular in shape, etc. Further, the bottom base component comprises side walls which line the perimeter and extend upward from the base. If the bottom base component is a rectangular shape, the component would comprise two sets of opposing side walls, extending up from the base. If the bottom base component is a circular shape, the component would comprise one side wall, extending along the perimeter of the base in a circular shape. The side walls help to retain the dessert and icing within the bottom base component, if the dessert is placed directly in the bottom base component; and/or the side walls help to retain the additional components on the turntable component.

In another embodiment, the bottom base component comprises at least two apertures or through holes, but preferably four apertures or through holes on the bottom of the base. These apertures or through holes accept a rubber stopper or plug, which is used to releasably secure the bottom base component to the turntable component. In another embodiment, the bottom base component is permanently secured to the turntable component via gluing, welding, etc.

In another embodiment, the bottom of the base comprises a non-skid bottom to further help the bottom base component secure to the turntable component. The non-skid bottom comprises any suitable design or imprint on the surface, which would help in retaining the bottom base component to the turntable component.

In another embodiment, the turntable component comprises an additional platform component permanently secured or releasably secured to the turntable component. The platform component can be any suitable shape or size as is known in the art and acts to support the bottom base component on the turntable component. The platform component can even extend out past the turntable component on either side. The platform component is not necessary, and the device can function without the platform component. However, as the platform component is typically manufactured of acrylic, polycarbonate, or plastic, etc., the platform component aids in securing the bottom base component to the turntable component via the rubber plugs.

In another embodiment, the rotating cake pan device further comprises a detachable drainage reservoir catch-pan or drip-pan component. The drip-pan component is sized to be retained within the bottom base component, and thus can be any size and shape as is known in the art, as long as the drip-pan component can be nested within the bottom base component. The drip-pan component comprises side walls which line the perimeter and extend upward from the base to catch the excess chocolate, glaze, icing, etc., which is drizzled on the dessert. Further, in one embodiment, the drip-pan device comprises a pour spout. The pour spout is typically manufactured of silicone or other like materials as is known in the art. The pour spout can be detachable and releasably secured to the drip-pan component, or the pour spout can be an integral part of the drip-pan component.

In one embodiment, the rotating cake pan device comprises a detachable cooling rack. The detachable cooling rack is sized to be retained within the drip-pan component, and thus can be any size and shape as is known in the art, as long as the cooling rack can be nested within the drip-pan component. The cooling rack retains the dessert to be decorated, while allowing the dessert to be cooled and then decorated. Typically, the cooling rack is a wire rack with a wire leg at each corner to allow the dessert placed on the cooling rack not to touch the contents of the drip-pan component. However, the cooling rack does not have to be a wire rack or have legs, as long as the cooling rack functions to cool the dessert item to be decorated and allows the dessert item not to contact the contents of the drip-pan component. For example, in one embodiment, the cooling rack can be a flat wire rack that sits directly on top of the drip-pan component and extends over the edges of the drip-pan component, so as not to contact the contents of the drip-pan component.

In one embodiment, the rotating cake pan device can rotate automatically via a motor. The motor would be in communication with at least one gear, and both would be positioned in the turntable component. The motor would be powered via batteries or via an electrical plug and wall outlet.

In one embodiment, the rotating cake pan device and its components can be manufactured of the same or different materials, such as acrylic, plastic or polymers, such as polypropylene or acrylonitrile-butadiene-styrene (ABS), polycarbonate, or metals, such as stainless steel or aluminum, or any other suitable materials as is known in the art.

In another embodiment, the rotating cake pan device comprises a plurality of indicia on the turntable component, the bottom base component, the drip-pan component, and/or the cooling rack.

In yet another embodiment, a method of decorating desserts while eliminating messy drips and drizzles is disclosed. The method includes the steps of providing a rotating cake pan device comprising a bottom base component and drip-pan positioned on a rotating turntable component. The method also comprises positioning a cake or other dessert on the bottom base component. Further, the method comprises rotating the turntable component while decorating the dessert. The method also comprises pouring icing or glaze over the rotating dessert on the bottom base component. Further, the method comprises collecting any excess icing or glaze within the drip-pan positioned on the bottom base component. Finally, the method ends with pouring the collected icing or glaze back onto the dessert or back into a storage container.

In yet another embodiment of the present invention, the rotating cake pan device provides users with a turntable component for decorating food items with glaze and icing. The device enables users to easily rotate the turntable component while decorating their items, simultaneously eliminating messy drips and drizzles. The user places the dessert to be decorated on the turntable component and then rotates the dessert via the device while decorating. During decoration, any excess glaze or icing will drip off the dessert and into the drip-pan component, where the glaze or icing can then be poured back onto the dessert or back into a storage container, using the pour spout of the drip-pan component.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the rotating cake pan device of the present invention in accordance with the disclosed architecture;

FIG. 2 illustrates a perspective exploded view of another embodiment of the rotating cake pan device of the present invention in accordance with the disclosed architecture;

FIG. 3 illustrates a perspective view of the rotating turntable component of the rotating cake pan device of the present invention in accordance with the disclosed architecture;

FIG. 4 illustrates a perspective view of the rotating cake pan device of the present invention in use in accordance with the disclosed architecture;

FIG. 5 illustrates a perspective view of the excess icing from the device being poured into a container in accordance with the disclosed architecture; and

FIG. 6 illustrates a flowchart showing the method of decorating desserts while eliminating messy drips and drizzles in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a rotating cake pan device that provides users with a turntable and tray system for decorating food items with glaze and icing. There is also a long-felt need in the art for a rotating cake pan device that prevents chocolate, glaze, and icing, etc., from being wasted, allowing it to be reused for future food items. Further, there is a long-felt need in the art for a rotating cake pan device that enables users to rotate the turntable while decorating their items to ensure the dessert is decorated from all sides and angles. Moreover, there is a long-felt need in the art for a device that features multiple trays and a drip pan that can be used to support food items for decorating. Further, there is a long-felt need in the art for a rotating cake pan device that allows excess glaze and icing to flow into the drip pan for pouring the icing back into a storage container. Finally, there is a long-felt need in the art for a rotating cake pan device that eliminates messy drips and drizzles from requiring extensive cleanup after desserts are decorated.

The present invention, in one exemplary embodiment, is a novel rotating cake pan device. The device comprises a bottom base component positioned on a rotating turntable component. A detachable drainage reservoir drip-pan and a detachable cooling rack are all placed on top of the bottom base component. The bottom base component comprises four rubber plugs and a non-skid bottom which secures the bottom base component to the rotating turntable component during use. The present invention also includes a novel method of decorating desserts while eliminating messy drips and drizzles. The method includes the steps of providing a rotating cake pan device comprising a bottom base component and drip-pan positioned on a rotating turntable component. The method also comprises positioning a cake or other dessert on the bottom base component. Further, the method comprises rotating the turntable component while decorating the dessert. The method also comprises pouring icing or glaze over the rotating dessert on the bottom base component. Further, the method comprises collecting any excess icing or glaze within the drip-pan positioned on the bottom base component. Finally, the method ends with pouring the collected icing or glaze back onto the dessert or back into a storage container.

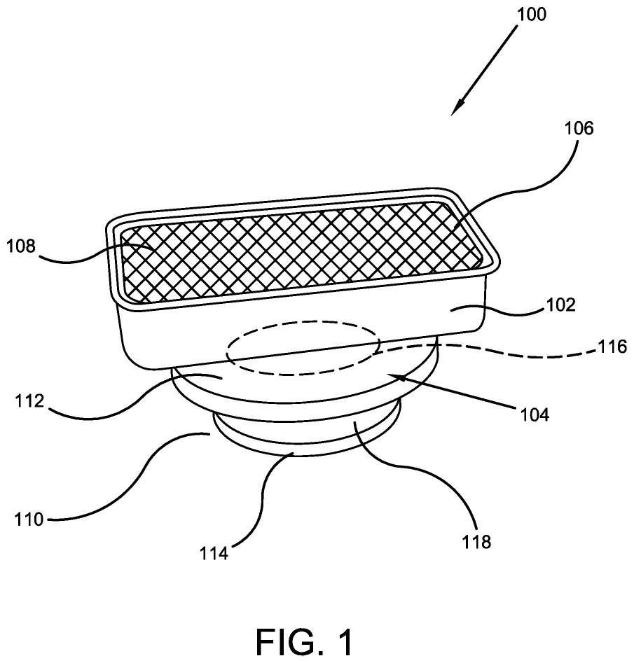

Referring initially to the drawings, FIG. 1 illustrates a perspective view of one embodiment of the rotating cake pan device 100 of the present invention. In the present embodiment, the rotating cake pan device 100 is an improved cake pan device that eliminates messy drips and drizzles during decoration and allows a user to rotate the dessert easily and effectively. The device 100 is especially designed to allow professional or commercial bakers and/or amateur bakers, or any other suitable user as is known in the art, to easily rotate their dessert during decoration and to collect excess icing. More specifically, the device 100 can be used to decorate a cake, pastries, strawberries, etc., or any other suitable desserts and/or food items as is known in the art, depending on the needs and/or wants of a user.

Furthermore, the rotating cake pan device 100 comprises a bottom base component 102 positioned on a rotating turntable component 104. A detachable drainage reservoir catch-pan or drip-pan 106 and a detachable cooling rack 108 are all placed on top of the bottom base component 102. However, any suitable number of additional components can be utilized with the rotating turntable component 104 as is known in the art, depending on the needs and/or wants of a user. Further, additional components can be utilized with the cooling rack 108 and drip-pan 106, or in place of them, depending on the needs and/or wants of a user.

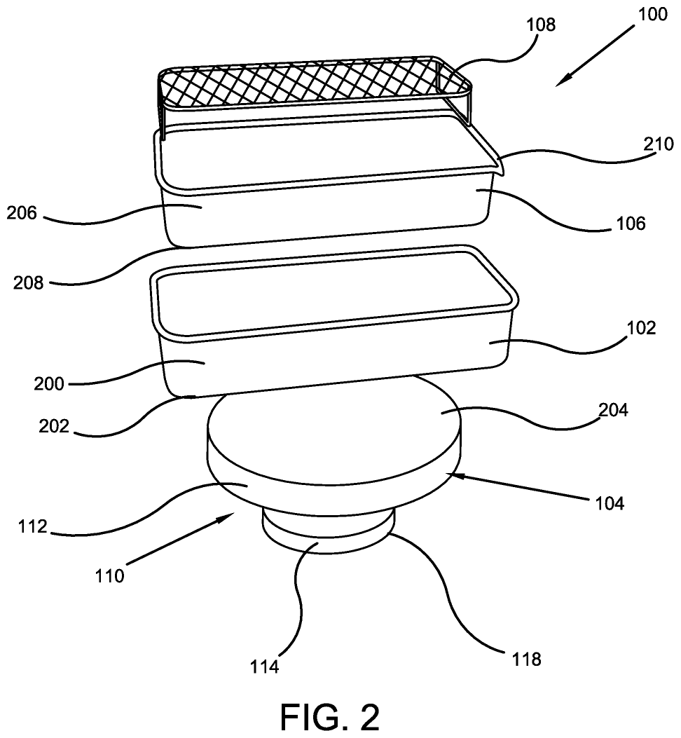

FIG. 2 illustrates a perspective view of another embodiment of the rotating cake pan device 100 of the present invention. In this embodiment, the rotating turntable component 104 of the device 100 comprises a rotational coupling or turntable assembly 110. The turntable assembly 110 includes an upper member, or rotating member 112 and a lower member, or base member 114. A plurality of bearing members 116, such as ball bearings, are interposed between the rotating member 112 and the base member 114 to facilitate relative rotation between the members 112 and 114. In addition, outer peripheral edges 118 of the members 112 and 114 are configured in an interlocking arrangement, which prevents separation of the members 112 and 114 in an axial direction.

In one embodiment, a bottom base component 102 is then secured to the turntable component 104. The bottom base component 102 can be any suitable size and/or shape as is known in the art, depending on the needs and/or wants of a user. For example, the bottom base component 102 can be rectangular, square, oval, or circular in shape, etc. Further, the bottom base component 102 comprises side walls 200 which line the perimeter and extend upward from the base 202. If the bottom base component 102 is a rectangular shape, the component 102 would comprise two sets of opposing side walls 200, extending up from the base 202. If the bottom base component 102 is a circular shape, the component 102 would comprise one side wall 200, extending along the perimeter of the base 202 in a circular shape. The side walls 200 help to retain the dessert and icing within the bottom base component 102, if the dessert is placed directly in the bottom base component 102; and/or the side walls 200 help to retain the additional components (i.e., cooling rack 108 and drip-pan 106, etc.) on the turntable component 104.

In another embodiment, the turntable component 104 comprises an additional platform component 204 permanently secured or releasably secured to the turntable component 104. The platform component 204 can be any suitable shape or size as is known in the art and acts to support the bottom base component 102 on the turntable component 104. The platform component 204 can even extend out past the turntable component 104 on either side. The platform component 204 is not necessary, and the device 100 can function without the platform component 204. However, as the platform component 204 is typically manufactured of acrylic, glass, polycarbonate, or plastic, etc., the platform component 204 aids in securing the bottom base component 102 to the turntable component 104 via a securing means (i.e., rubber plugs, etc.).

In another embodiment, the rotating cake pan device 100 further comprises a detachable drainage reservoir catch-pan or drip-pan component 106. The drip-pan component 106 is sized to be retained within the bottom base component 102, and thus can be any size and shape as is known in the art, as long as the drip-pan component 106 can be nested within the bottom base component 102. The drip-pan component 106 comprises side walls 206 which line the perimeter and extend upward from the base 208 to catch the excess chocolate, glaze, icing, etc., which is drizzled on the dessert. Further, in one embodiment, the drip-pan device 106 comprises a pour spout 210. The pour spout 210 is typically manufactured of silicone or other like materials as is known in the art. The pour spout 210 can be detachable and releasably secured to the drip-pan component 106, or the pour spout 210 can be an integral part of the drip-pan component 106.

In one embodiment, the rotating cake pan device 100 comprises a detachable cooling rack 108. The detachable cooling rack 108 is sized to be retained within the drip-pan component 106, and thus can be any size and shape as is known in the art, as long as the cooling rack 108 can be nested within the drip-pan component 106. The cooling rack 108 retains the dessert to be decorated, while allowing the dessert to be cooled and then decorated. Typically, the cooling rack 108 is a wire rack with a wire leg at each corner to allow the dessert placed on the cooling rack 108, not to touch the contents of the drip-pan component 106. However, the cooling rack 108 does not have to be a wire rack or have legs, as long as the cooling rack 108 functions to cool the dessert item to be decorated and allows the dessert item not to contact the contents of the drip-pan component 106. For example, in one embodiment, the cooling rack 108 can be a flat wire rack that sits directly on top of the drip-pan component 106 and extends over the edges of the drip-pan component 106, so as not to contact the contents of the drip-pan component 106.

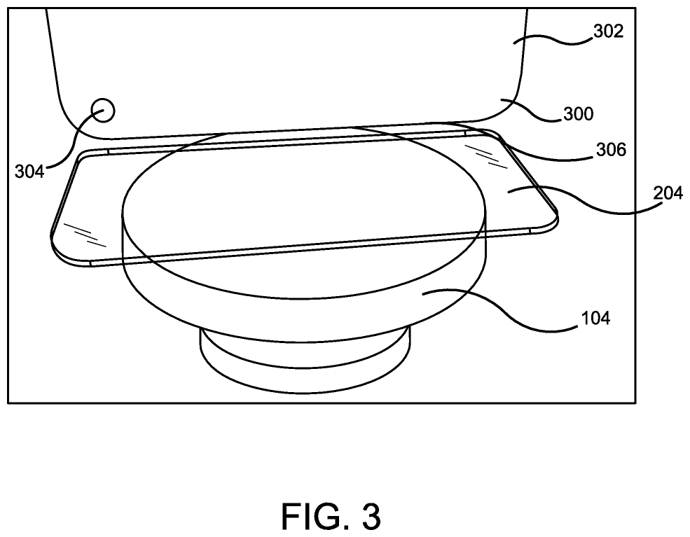

FIG. 3 illustrates a perspective view of another embodiment of the rotating cake pan device 100 of the present invention. In this embodiment, the bottom base component 102 comprises at least two apertures or through holes 300, but preferably four apertures or through holes 300 on the bottom 302 of the base 202. These apertures or through holes 300 accept a rubber stopper or plug 304, which is used to releasably secure the bottom base component 102 to the turntable component 104. In another embodiment, the bottom base component 102 is permanently secured to the turntable component 104 via gluing, welding, etc.

In another embodiment, the bottom 302 of the base 202 comprises a non-skid bottom 306 to further help the bottom base component 102 secure to the turntable component 104. The non-skid bottom 306 comprises any suitable design or imprint on the surface, which would help in retaining the bottom base component 102 to the turntable component 104.

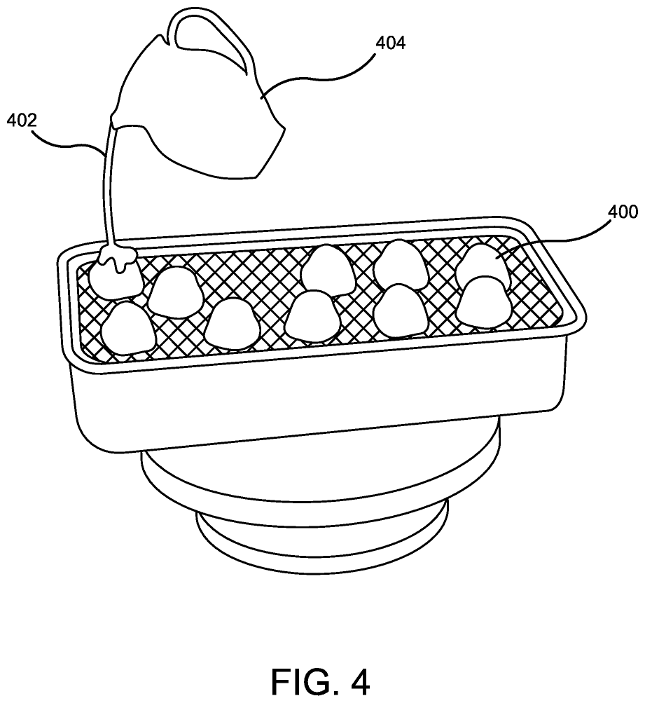

FIG. 4 illustrates a perspective view of another embodiment of the rotating cake pan device 100 of the present invention in use. Specifically, the rotating cake pan device 100 provides users with a turntable component 104 for decorating food items 400 with glaze and icing 402. The device 100 enables users to easily rotate the turntable component 104 while decorating their items 400, while simultaneously eliminating messy drips and drizzles. The user places the dessert 400 to be decorated on the turntable component 104 and then rotates the dessert 400 via the device 100 while decorating. During decoration, any excess glaze or icing 402 will drip off the dessert 400 and into the drip-pan component 106, where the glaze or icing 402 can then be poured back onto the dessert 400 or back into a storage container 404, using the pour spout 210 of the drip-pan component 106.

In one embodiment, the rotating cake pan device 100 and its components 102, 104, 106, and 108 can be manufactured of the same or different materials, such as acrylic, plastic or polymers, such as polypropylene or acrylonitrile-butadiene-styrene (ABS), polycarbonate, or metals, such as stainless steel or aluminum, or any other suitable materials as is known in the art.

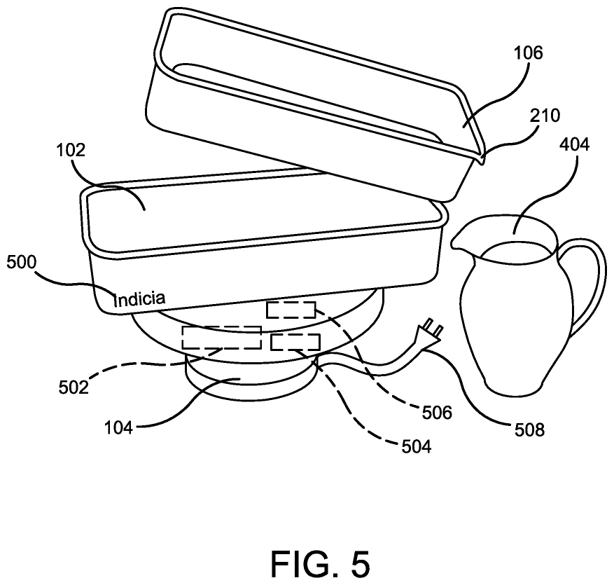

FIG. 5 illustrates a perspective view of another embodiment of the rotating cake pan device 100 of the present invention in use. In this embodiment, the rotating cake pan device 100 comprises a plurality of indicia 500 on the turntable component 104, the bottom base component 102, the drip-pan component 106, and/or the cooling rack 108. For example, the components 102, 104, 106 and 108 may include advertising, a trademark, or other letters, designs, or characters, printed, painted, stamped, engraved, or integrated into the device 100, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be cooking or brand related.

In another embodiment, the rotating cake pan device 100 can rotate automatically via a motor 502. The motor 502 would be in communication with at least one gear 504, and both would be positioned in the turntable component 104. The motor 502 would be powered via batteries 506 or via an electrical plug 508 and wall outlet.

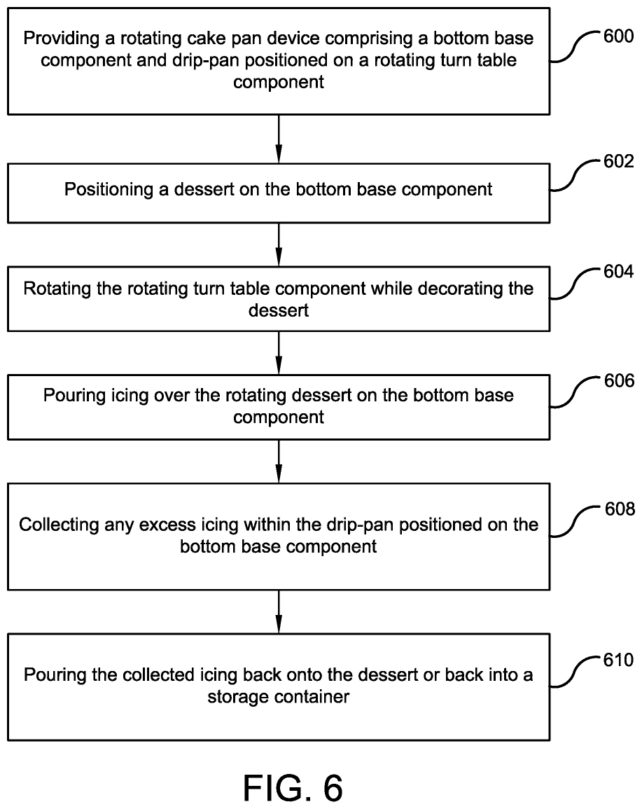

FIG. 6 illustrates a flowchart of the method of decorating desserts while eliminating messy drips and drizzles. The method includes the steps of at 600, providing a rotating cake pan device comprising a bottom base component and drip-pan positioned on a rotating turntable component. The method also comprises at 602, positioning a cake or other dessert on the bottom base component. Further, the method comprises at 604, rotating the turntable component while decorating the dessert. The method also comprises at 606, pouring icing or glaze over the rotating dessert on the bottom base component. Further, the method comprises at 608, collecting any excess icing or glaze within the drip-pan positioned on the bottom base component. Finally, the method ends at 610, with pouring the collected icing or glaze back onto the dessert or back into a storage container.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “rotating cake pan device,” “cake pan device,” and “device” are interchangeable and refer to the rotating cake pan device 100 of the present invention.

Notwithstanding the foregoing, the rotating cake pan device 100 of the present invention can be of any suitable size and configuration as is known in the art without affecting the overall concept of the invention, provided that it accomplishes the above-stated objectives. One of ordinary skill in the art will appreciate that the rotating cake pan device 100 as shown in FIGS. 1-6 is for illustrative purposes only, and that many other sizes and shapes of the rotating cake pan device 100 are well within the scope of the present disclosure. Although the dimensions of the rotating cake pan device 100 are important design parameters for user convenience, the rotating cake pan device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rotating cake pan device comprising:
a bottom base component;
a rotating turntable component; and
a drip-pan, wherein the bottom base component is positioned on the rotating turntable component, and further wherein the drip-pan nests within the bottom base component.

2. The rotating cake pan device of claim 1, wherein the rotating turntable component comprises a turntable assembly having a rotating member and a lower member.

3. The rotating cake pan device of claim 2, wherein a plurality of bearing members are interposed between the rotating member and the base member to facilitate relative rotation.

4. The rotating cake pan device of claim 3, wherein outer peripheral edges of the rotating member and the base member are configured in an interlocking arrangement, which prevents separation.

5. The rotating cake pan device of claim 1, wherein the bottom base component comprises side walls which extend upward from a base.

6. The rotating cake pan device of claim 1 further comprising an additional platform component secured to the rotating turntable component.

7. The rotating cake pan device of claim 1, wherein the drip-pan comprises side walls which extend upward from a base.

8. The rotating cake pan device of claim 7, wherein the drip-pan comprises a pour spout.

9. The rotating cake pan device of claim 1 further comprising a cooling rack retained within the drip-pan.

10. The rotating cake pan device of claim 1, wherein the bottom base component comprises at least two apertures on a bottom of the bottom base component.

11. The rotating cake pan device of claim 10, wherein the at least two apertures accept a rubber plug which releasably secures to the rotating turntable component.

12. The rotating cake pan device of claim 1, wherein the bottom base component comprises a non-skid bottom.

13. The rotating cake pan device of claim 1 further comprising a plurality of indicia.

14. A rotating cake pan device comprising:
a bottom base component comprised of side wall that extends upward from a base;
a drip-pan comprised of a side wall that extends upward from a base; and
a rotating turntable component comprised of a turntable assembly that includes a rotating member and a lower member, and a plurality of bearing members interposed between the rotating member and the lower member to facilitate relative rotation;
wherein outer peripheral edges of the rotating member and the lower member are configured in an interlocking arrangement, which prevents separation; and
wherein the bottom base component is positioned on the rotating turntable component; and
further wherein the drip-pan nests within the bottom base component.

15. The rotating cake pan device of claim 14 further comprising a cooling rack retained within the drip-pan.

16. The rotating cake pan device of claim 14, wherein the bottom base component comprises at least two apertures on a bottom of the bottom base component.

17. The rotating cake pan device of claim 16 wherein the at least two apertures are sized and configured to accept a rubber plug that releasably secures to the rotating turntable component.

18. The rotating cake pan device of claim 14, wherein the bottom base component comprises a non-skid bottom.

19. The rotating cake pan device of claim 14, wherein the rotating cake pan device rotates automatically via a motor in communication with at least one gear.

20. A method of decorating a dessert while eliminating messy drips and drizzles, the method comprising the steps of:
providing a rotating cake pan device comprising a bottom base component and a drip-pan positioned on a rotating turntable component;
positioning the dessert on the bottom base component;
rotating the rotating turntable component while decorating the dessert;
pouring an icing over the dessert on the bottom base component as it is being rotated;
collecting any excess icing within the drip-pan positioned on the bottom base component; and
pouring the collected excess icing back onto the dessert or back into a storage container.
